(19) United States
(12) Patent Application Publication
(10) Pub. No.: US 2015/0254710 A1
(43) Pub. Date: Sep. 10, 2015

(54) Systems and Methods for Interfacing with Footwear Enthusiasts

(71) Applicants: Dubrey M. Black, Hilliard, OH (US); Wayne M. Carr, Hilliard, OH (US)

(72) Inventors: Dubrey M. Black, Hilliard, OH (US); Wayne M. Carr, Hilliard, OH (US)

(73) Assignee: FRESH AND HUMBLE, LLC, Hilliard, OH (US)

(21) Appl. No.: 14/197,184

(22) Filed: Mar. 4, 2014

(51) Int. Cl. G06Q 30/02; G06Q 50/00; G06Q 30/06

(52) U.S. Cl. CPC G06Q 30/0255; G06Q 30/0257; G06Q 30/0633; G06Q 50/01

(57) ABSTRACT

A system and a method are disclosed for facilitating electronic messages in a footwear enthusiast message sharing system. Footwear enthusiasts can post messages to the message sharing system. These messages from posting users are received by the system and sent to receiving users that have subscribed to the posting users. The receiving users interact with the messages in various ways, such as by sharing the messages with other users.

### RELATED APPLICATIONS

This application claims the benefit of, and priority to, the following application: U.S. Provisional Application No. 61/772,352, filed Mar. 4, 2013, entitled “Systems and Methods for Providing Enhanced Access to Footwear Enthusiasts Using a Portable Electronic Device.”

### BACKGROUND

1. Field of Invention

This disclosure generally relates to the field of electronic messages, and more particularly footwear related message sharing and transactions.

2. Description of Related Art

Footwear is more than shoes for many people—they're a way of life. Be it as cultural signifiers or performance enhancers, the phenomenon of contemporary sneaker culture has gone far beyond functional fashion. Many footwear enthusiasts would simply describe this sub-cultural phenomenon as—you are what you wear. Moreover, sneakers are a springboard way to see pieces of a wearer's personality.

Many systems exist for sharing electronic messages among a community of footwear enthusiasts. Examples of enhanced access systems include Internet forums, electronic mailing lists, blogs and microblogs, and social networks. In any of these systems, users may post messages that can be read by other users of the system. For example, in a social networking website, a user may post a message that can be read by other users that are connected to the posting user through the website. In some systems, a user can subscribe to the postings of another user (which can be an individual, a company, or some other entity) and subsequently receive some or all of the postings of that user. For example, a user subscribed to another user in a social network may receive all of the postings of that user. A user that subscribes to postings of another user is also referred to as a “subscriber” (or “follower”) of that user.

Many footwear enthusiasts use one or more methods to gain access to footwear enthusiast communities. Such footwear enthusiasts have also demonstrated an interest in recording their footwear collection activities, displaying their connection with footwear, and expressing their affinity with footwear to other enthusiasts associated therewith. Accordingly, various mediums may be used to detect, store, and/or transmit footwear information. Oftentimes, however, information for footwear enthusiasts is fragmented, presented in a vacuum or based on the perspectives of singular footwear manufacturers. Thus, therein is lacking, inter alia, message sharing systems that present enhanced access to footwear enthusiasts seeking to obtain additional information about the footwear culture.

### SUMMARY

This Summary is included so as to introduce, in an abbreviated form, various topics to be elaborated upon below in the Detailed Description. This Summary is not intended to identify key or essential aspects of the claimed invention. This Summary is similarly not intended for use as an aid in determining the scope of the claims. The following summary merely presents some concepts of the invention in general form.

This is directed to systems and methods for interface mechanics in footwear enthusiast messaging in accordance with some embodiments of the system. In particular, this is directed to message sharing amongst footwear enthusiasts through an integrated application of an electronic device.

One embodiment of a disclosed system, method and computer readable storage medium is configured to recommend electronic messages in a message sharing system. Users can post messages to the message sharing system. These messages from posting users are received by the system and sent to receiving users that have subscribed to the posting users. The receiving users interact with the messages in various ways, such as by sharing the messages with other users. Interaction information is received for each of the electronic messages. The interaction information includes an indication of the number of interactions with the electronic message by receiving users.

In some embodiments, the message sharing system can provide a user with footwear exchange opportunities. For example, the message sharing system may access a database of footwear items currently owned by the user. Based on that database, the message sharing system may locate footwear items available for purchase from one or more footwear providers or manufacturers. As another example, the footwear enthusiast message sharing system can use historical data to identify buying trends of a particular user, while footwear manufacturers and providers can deliver personalized notifications directly to the user's electronic device.

In some embodiments, the messaging system can provide a user with enhanced interface mechanics relating to footwear items. For example, footwear items may incorporate distinct optical patterns and/or novel design specifications (e. g., a trademark) and novel design specifications. A user may then scan the optical pattern and/or design specifications to obtain additional information or features associated with that footwear item. For example, the optical pattern and novel design specifications may be scanned by taking a digital image of the footwear item with a camera of the user's electronic device. By analyzing (e.g. taking into account the similarity between the respective footwear item image and the potential footwear item) the digital image of the optical pattern and/or novel design specifications, the message sharing system may access information associated with the footwear item such as ratings, availability (e.g., in a particular size, color, style, or the like), comparisons (e.g., price comparisons of the same or similar items from footwear providers and manufacturers or store locations), and other suitable features.

In some embodiments, the footwear enthusiast message sharing system can provide functions to attract or entice a user to view a particular footwear item, manufacturer or provider. For example, through the message sharing system, a user can be provided with promotions and invitations to special events, user initiated sales alerts, geographic location information, access product availability, determine retail store locations, and be provided with opportunities to pre-order and reserve footwear items.

In some aspects, the footwear enthusiast message sharing system can provide enhanced footwear item information to a user. For example, a user may scan an advertisement including a barcode, embedded pixel pattern, or other information-including pattern with an electronic device. By doing so, the user can access enriched information associated with the footwear item of the advertisement. As another example, social networking features can be incorporated by allowing a user to create wish lists, look books, gift guides, or other collections of footwear items. These collections may then be provided to a social website or otherwise shared such that friends and acquaintances can provide feedback on footwear collections.

In some embodiments, the message sharing system can provide functions to insure that footwear enthusiasts can recover their footwear item collection in the unlikely event that a user becomes the victim of a crime wherein the footwear is removed from a user. This will allow for footwear enthusiasts to be made whole in the event of theft or any other happenings that would cause a footwear enthusiast to suffer a loss. With insurance-like features, because of the unique nature of protection, a user would be compensated based on the current resell/market value for each footwear item.

### OBJECTS & ADVANTAGES

Providing enhanced access to a community of footwear enthusiasts through the present disclosure creates both financial and management benefits. Benefits include:
maximizing targeted advertising;
reducing costs of footwear secondary market transactions;
leveraging real time consumer buying habits; and
insuring footwear enthusiasts against potential theft or fraud

However, there are also unanticipated human and management benefits that come with the present messaging system, including a convenient way to stay connected with other enthusiast who share a passion for footwear, while creating a platform where footwear enthusiasts can view sneakers, and the like as status symbols; not necessarily a symbol of wealth but of something money can't buy—the rare commodity of cool.

### BRIEF DESCRIPTION OF THE DRAWINGS

FIG. 1—shows a schematic view of the electronic device

FIG. 2—shows a schematic view of functions for polling a user

FIG. 3—shows a schematic view of functions for navigating a user through a message sharing system via an exemplary homepage interface

FIG. 4—shows a schematic view of functions for navigating a user through a message sharing system via an exemplary profile interface

FIGS. 5a & 5b—shows schematic views of functions for navigating a user through a message sharing system via exemplary marketplace interfaces

FIG. 6—shows schematic views of functions for navigating a user through a message sharing system via an exemplary timeline interface

FIG. 7—shows schematic views of functions for navigating a user through a message sharing system via exemplary my & preferred closet interfaces

FIG. 8—shows a schematic view of functions for capturing images through a message sharing system via an exemplary camera interface

FIG. 9—shows a schematic view of functions for navigating a user through a message sharing system via exemplary cop list & advertisement interfaces

FIG. 10—shows a schematic view of functions for navigating a user through a message sharing system via an exemplary search interface

FIG. 11—shows a schematic view of one embodiment of a process for facilitating messages to footwear enthusiasts

FIG. 12—shows a schematic view of one embodiment of a system for facilitating footwear enthusiast messages in a message sharing system

### DETAILED DESCRIPTION

### Recommended System

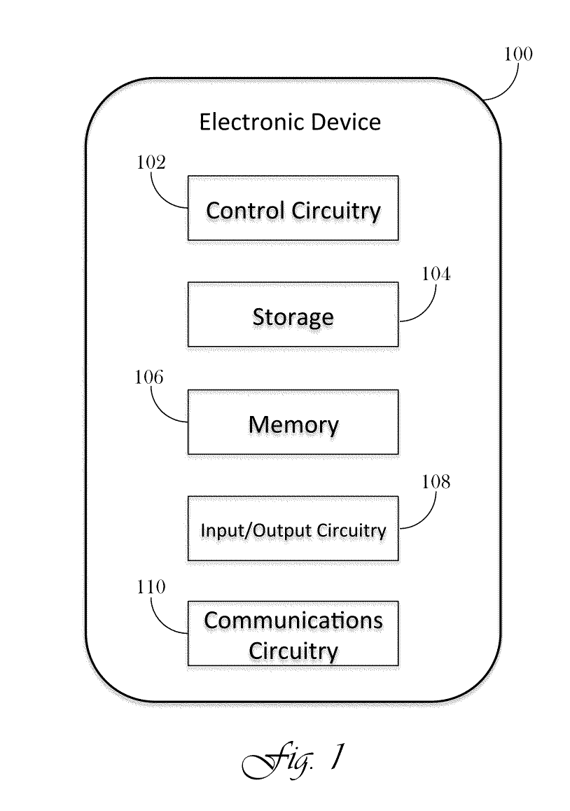

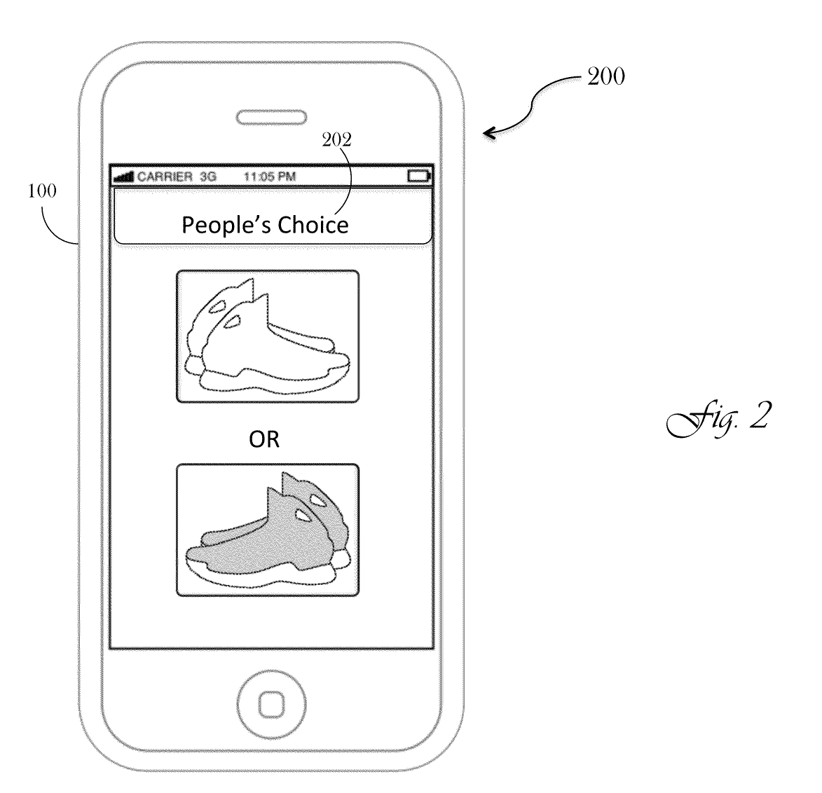

FIG. 1 is a schematic view of an illustrative electronic device for providing an application operative to interface with footwear enthusiasts in accordance with some embodiments of the message sharing system. Electronic device 100 can include control circuitry 102, storage 104, memory 106, input/output (“I/O”) circuitry 108, and communications circuitry 110. In some embodiments, one or more of the components of electronic device 100 can be combined or omitted (e.g., storage 104 and memory 106 may be combined). In some embodiments, electronic device 100 can include other components not combined or included in those shown in FIG. 1 (e.g., motion detection components, a power supply such as a battery or kinetics, a display, bus, a positioning system, a camera, an input mechanism, etc.), or several instances of the components shown in FIG. 1. For the sake of simplicity, only one of each of the components is shown in FIG. 1.

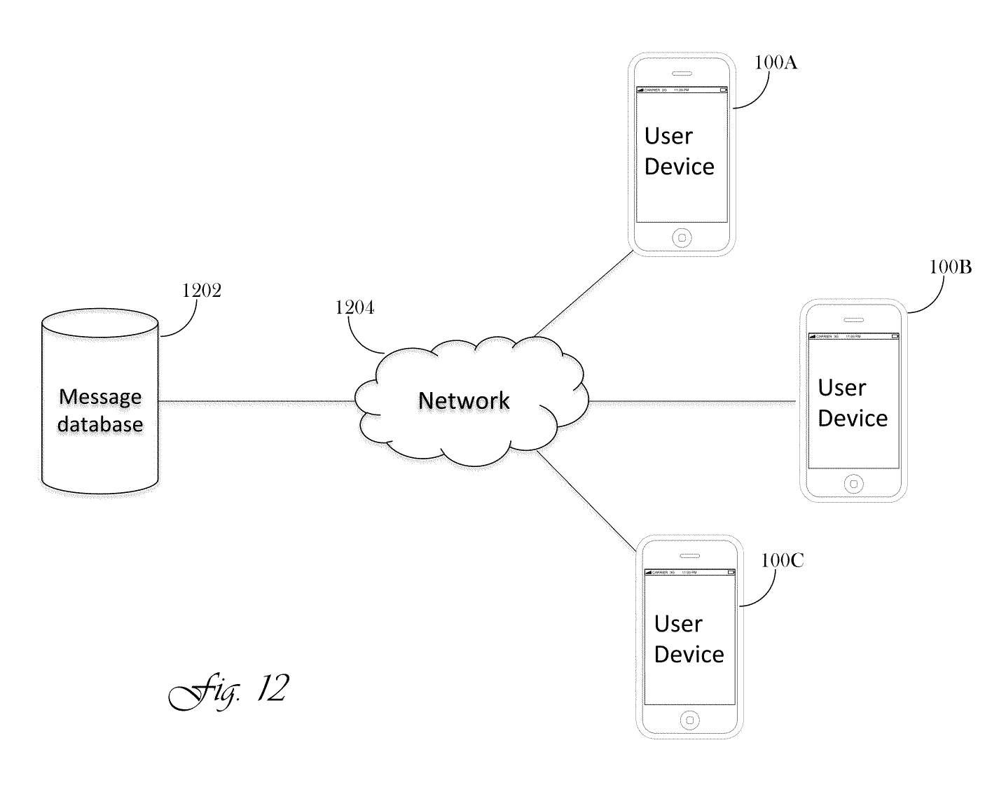

Electronic device 100 can include any suitable type of electronic device. For example, electronic device 100 (as also illustrated in FIG. 12 user device 100A-C) can include a portable electronic device that the user may hold in his or her hand, such as a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a tablet computer (e.g., an iPad™ made available by Apple Inc. of Cupertino, Calif.), a handheld gaming device, a smartwatch wrist computation device and a digital camera. As another example, electronic device 100 can include a larger portable electronic device, such as a laptop computer. As yet another example, electronic device 100 can include a substantially fixed electronic device, such as a desktop computer.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drives display and process inputs received from a user interface.

Storage 104 can include, for example, one or more storage mediums including a hard-drive, solid state drive, flash memory, permanent memory such as ROM, any other suitable type of storage component, or any combination thereof. Storage 104 can store, for example, media data (e.g., music and video files), application data (e.g., for implementing functions on electronic device 100), firmware, user preference information data (e.g., footwear collection preferences), authentication information (e.g. libraries of data associated with authorized users), lifestyle information data (e.g., footwear preferences), exercise information data (e.g., information obtained by exercise monitoring equipment), transaction information data (e.g., information such as credit card information), wireless connection information data (e.g., information that can enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM, and/or one or more different types of memory used for temporarily storing data. In some embodiments, memory 106 can also be used for storing data used to operate electronic device applications, or any other type of data that can be stored in storage 104. In some embodiments' memory 106 and storage 104 can be combined as a single storage medium.

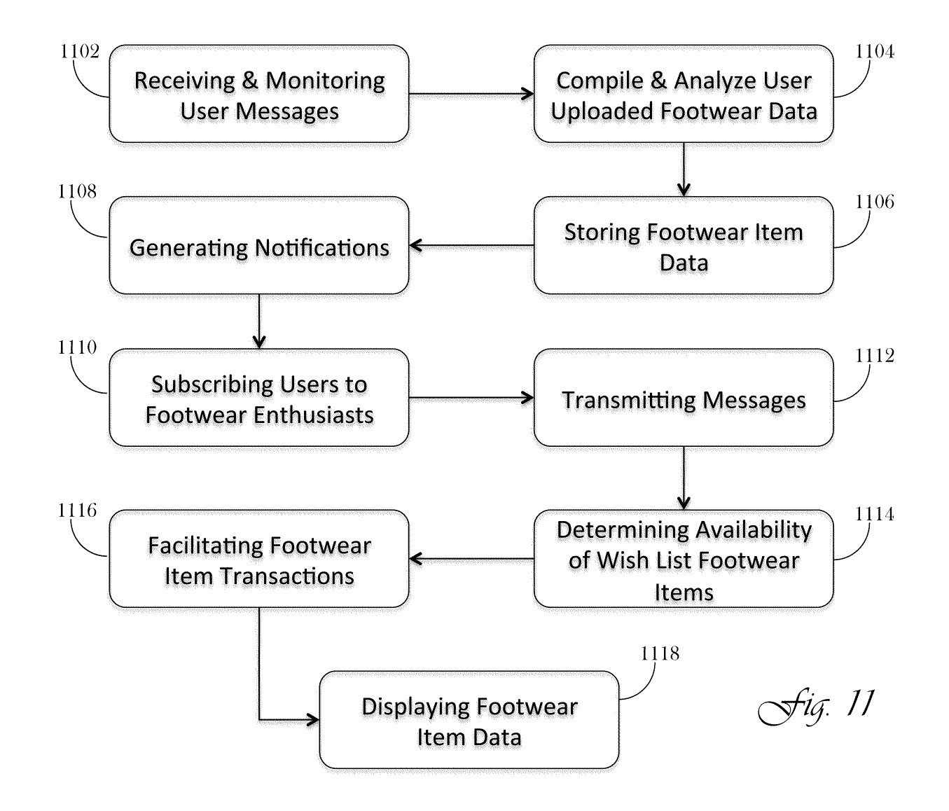

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), video signals (e.g., from a camera or camcorder) or any other input. The digital data can be provided to 1112 and received from 1112, as illustrated in FIG. 11, control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive sensing mechanism, or multi-touch capacitive sensing mechanisms.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or ear buds that can be coupled to communications device with a wire or wirelessly).

In some embodiments, I/O circuitry 108 can include display circuitry (e.g., a screen or projection system) for providing a display 1118 visible to the user. For example, the display circuitry can include a screen (e.g., an LCD screen) that is incorporated in electronics device 100. As another example, the display circuitry can include a movable display or a projecting system for providing a display 1118 of content on a surface remote from electronic device 100 (e.g., a video projector). In some embodiments, the display circuitry can include a coder/decoder (CODEC) to convert digital media data into analog signals. For example, the display circuitry (or other appropriate circuitry within electronic device 100) can include video CODECs, audio CODECs, or any other suitable type of CODEC.

The display circuitry also can include display driver circuitry, circuitry for driving display drivers, or both. The display circuitry can be operative to display content 1118 (e.g., media playback information, application screens for applications implemented on the electronic device, generating notifications 1108, information regarding incoming communications requests 1102, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data 1112) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, YOIP, or any other suitable protocol.

In some embodiments, communications circuitry 110 can be operative to create a communications network using any suitable communications protocol. For example, communications circuitry 110 can create a short-range communications network 1204, as illustrated in FIG. 12, using a short-range communications protocol to connect to other devices. For example, communications circuitry 110 can be operative to create a local communications network using the Bluetooth® protocol to couple electronic device 100 with a Bluetooth® headset.

Electronic device 100 can include one more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over an exemplary cellular network 1204, as shown in FIG. 12, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled to a host device for data transfers, synching the communications device, software or firmware updates, providing footwear item information to a remote source (e.g., providing user footwear preferences, buying habits, and demographic information to a remove server/database 1202) or performing any other suitable operation that can require electronic device 100 to be coupled to a host device. Several electronic devices 100 can be coupled to a single host device using the host device as a server/database 1202. Alternatively or additionally, electronic device 100 can be coupled to several host devices (e.g., for each of the plurality of the host devices to serve as a backup for data stored in electronic device 100).

### Recommended Process

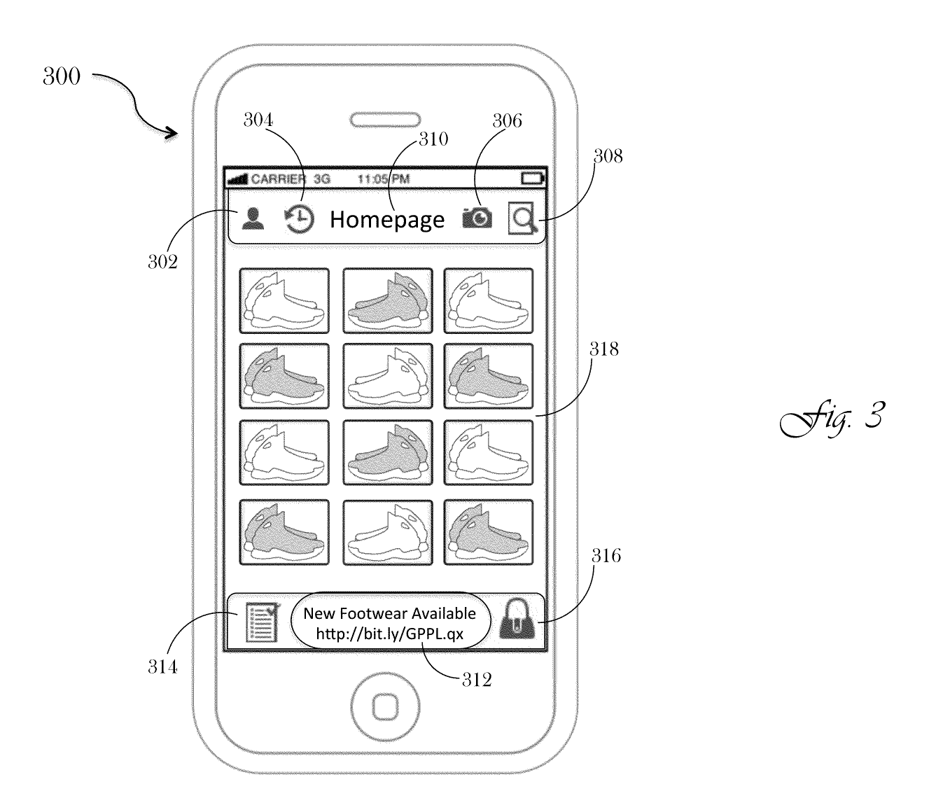

FIG. 2 shows a diagram 200 of functions available to a user for expressing user opinions in accordance with some embodiments. For example, upon sign in or launch, the footwear enthusiast message sharing system can poll users to provide a regular opportunity for users to express opinions 1102 on footwear designs. For example, survey 202 shows an exemplary survey to footwear designs that can be provided via an integrated application of electronic device 100.

As shown in the diagram 300, the message sharing system can provide a user with a Homepage Interface 310 via an integrated application preferably installed on an electronic device, allowing a user to navigate throughout various embodiments of message sharing system. For example, in some embodiments, a user can access a Profile Interface 302, Timeline Interface 304, Camera Interface 306, and Search Interface 308 via display 1118 icons.

In some embodiments, the message sharing system can allow a user to receive updates 1102 and compile footwear data 1104 from various constituents amongst the footwear enthusiast community. For example, updates can be viewed via the Ticker module 312 which will display information regarding sales, generating notifications 1108, release dates, and all footwear related information from various sources.

In other embodiments, each time a user returns to the Homepage Interface 310, a multitude of randomly selected footwear photos 318 will be displayed. For example, sources of home page photos 318, such as the My Closet Interface 702, the Preferred Closets Interface 704, the Sneaker Reel module 404, or any combination thereof, are customizable by a user. By simply touching any footwear photo on the page, it can take a user to the profile of the photograph owner, allowing a user to engage using message sharing to request and receive feedback 1112.

In some aspects, the message sharing system displays 1118 a Cop List icon 314 where users can be hyperlinked to the Cop List Interface 902 to add and/or subtract footwear items from their wish list. In addition, some embodiments can display a Market Place icon 316 where users can be hyperlinked to the Market Place Interfaces 502, 504, 506, & 508 that permit footwear item elimination from the Cop List Interface 902 after purchase or listing expendable footwear items for exchange.

As is also indicated by the diagram 400, the message sharing system can provide a user with a customizable messaging experience through enriched interfaces. For example, a user can customize profile pictures, screen names, and other social networking features while interacting with the footwear enthusiast community. The Profile Interface 402 captures personal information, such as size, sneaker preferences, buying habits, and demographic information shared with the footwear enthusiast community.

In one embodiment, the Profile Interface 402 can permit a user to view 1118 their footwear collections. For example, the Sneaker Reel module 404 allows a user to scroll horizontally through uploaded picture content. In addition, the My Closet hyperlink 406 takes a user to the My Closet Interface 702 allowing a user to see all the footwear enthusiast community members that have subscribed to the user's profile. Conversely, the Preferred Closets hyperlink 408 sends a user to the Preferred Closets interface 704 displaying footwear enthusiasts' information that a user has subscribed to receive.

In another embodiment, said Profile Interface 402 can serve as a command center for communications 1112. For example, the Notifications hyperlink 410 takes a user to an exemplary interface for receiving comments 1102, advice, messages, recommendations, and other feedback from members of a social network. Furthermore, said Profile Interface 402 can monitor upcoming releases 1102 via the Release Date hyperlink 412, add shoes to a calendar of release dates, or add an upcoming release to the Cop List Interface 902.

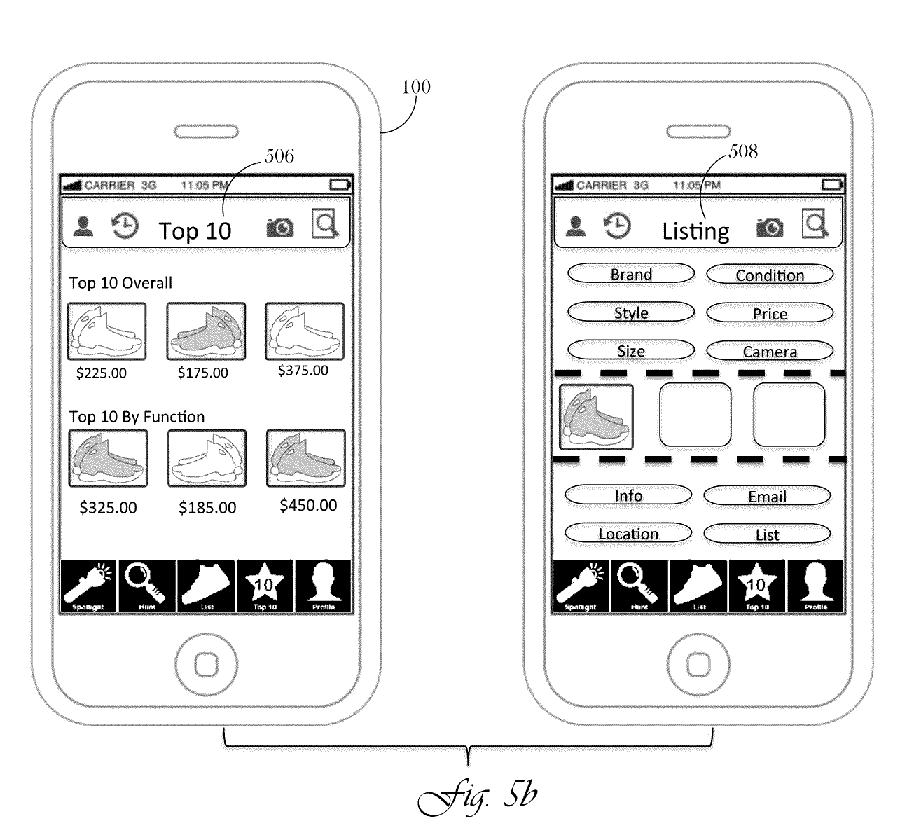

FIG. 5a shows a diagram of the Marketplace Spotlight Interface 502 available to a user in accordance with some embodiments of the system. Moreover, the message sharing system on the electronic device 100 utilizes the Marketplace Spotlight Interface 502 to keep a user abreast 1108 of the latest and most popular footwear offerings from top brands. In addition, FIG. 5a displays the Marketplace Buying Interface 504 of the message sharing system that highlights recent listings within the marketplace. As an illustration, the Marketplace Buying Interface 504 facilitates the narrowing of marketplace queries by directing users to listings of their preference.

Furthermore, the message sharing system on the electronic device 100 of FIG. 5b displays 1118 a Marketplace Listing Interface 508 where a user can list expendable footwear items for sale. As also indicated by FIG. 5b, in accordance to some embodiments of the system, the Top 10 Interface 506 tabulates the top 10 overall postings 1104, calculates the offerings of top sellers 1114, and displays top performing footwear separated by category and/or function.

In some embodiments, the message sharing system can provide the user the ability to rate a particular footwear item. Within the Timeline Interface 602 a user subscribed 1110 to another user amongst the footwear enthusiast message sharing system may receive all of the profile information, postings and footwear catalogs of that user. The color rating module 604 will be the result from an average of all ratings (1-5); one exemplary scale, the bolder the red, the higher the ranking. A user can engage the picture to reveal enriched information about the posting allowing the user to view the comments, rate the photo and add comments.

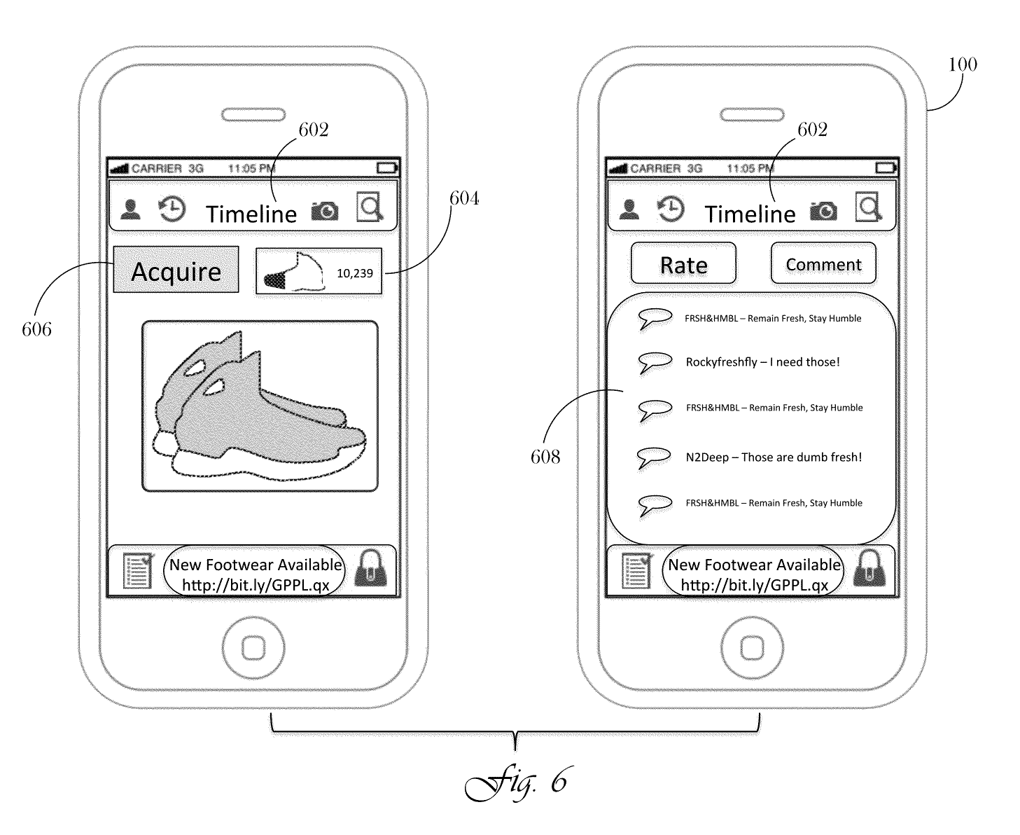

As illustrated in FIG. 6, the Timeline Interface 602 allows a user to search for potential purchases 1114 via the Acquire module 606. Once activating said Acquire module 606, a user can be taken to an external site (e.g., said communication circuitry 110 of FIG. 1) that returns results via network 1204 where a footwear item may be available for purchase. Furthermore, the Acquire module 606 can employ a seamless check out process, provided that billing information has been submitted the message sharing system. A seamless check out process will require regular verification of preferred purchasing methods and the availability of funds. Additionally, in some aspects, the message sharing system can employ the Acquire module 606 to facilitate exclusive transactions 1116 for elite footwear enthusiasts. Once categorized as an elite footwear enthusiast, said message sharing system installed on the electronic device 100 can guarantee that elite footwear enthusiasts will not have to wait in line at brick-and-mortar retail facilities or pursue other means of acquiring high demand footwear items.

For example, the message sharing system can include one or more algorithms operative to make purchase 1116 or donation recommendations 1116 by comparing and contrasting footwear items from said My Closet Interface 702, the Preferred Closets Interface 704, said Sneaker Reel module 404, or any combination thereof, with one or more footwear items available for purchase 1116 or donation 1116. For example, Timeline Interface 602 is an exemplary interface for providing footwear item recommendations to a user for purchase, exchange, donation, or adding to the Cop List Interface 902. The message sharing system interfaced with the electronic device 100 may search footwear items available for purchase from one or more footwear enthusiasts or retail providers (e.g., by accessing a database 1106 & 1202 of footwear items of footwear retailers, via said communication circuitry 110 of FIG. 1). In some embodiments, the user can purchase 1116 the recommended footwear items through the Timeline Interface 602 via the Acquire module 606 (e.g., by transmitting credit card or other payment information to the footwear enthusiast or retailer through a secure server via said communication circuitry 110 of FIG. 1).

In another embodiment, the Timeline Interface 602 allows a user to rate and review footwear, retailers, providers, or any combination of the above after evaluating a footwear item. In some embodiments, the message sharing system can submit ratings 1112 directly from a user's electronic device. For example, comment screen 608 shows an exemplary method of providing a user with an opportunity for leaving a rating or review through an electronic device 100. A color based rating method may result from an average of all ratings (1-5); for example, the bolder the red, the more popular the picture.

A user can, in some aspects, subscribe 1110 to the postings of another user (which can be an individual, a company, or some other entity) and subsequently receive some or all of the postings of that user. For example, a user subscribed 1110 to another user in the footwear enthusiasts message sharing system may receive all of the postings 1112 of that user. A user that subscribes 1110 to postings of another user is also referred to as a “subscriber” (or “follower”) of that user.

In some embodiments, an electronic device (e.g., electronic device 100 of FIG. 1 or 100A-C of FIG. 12) may include an integrated application operative to display 1118 the My Closet Interface 702 allowing a user to see all footwear enthusiast community members that have subscribed 1110 to the user's profile. Conversely, the Preferred Closets Interface 704 displays footwear enthusiasts' information that a user has subscribed 1110 to receive.

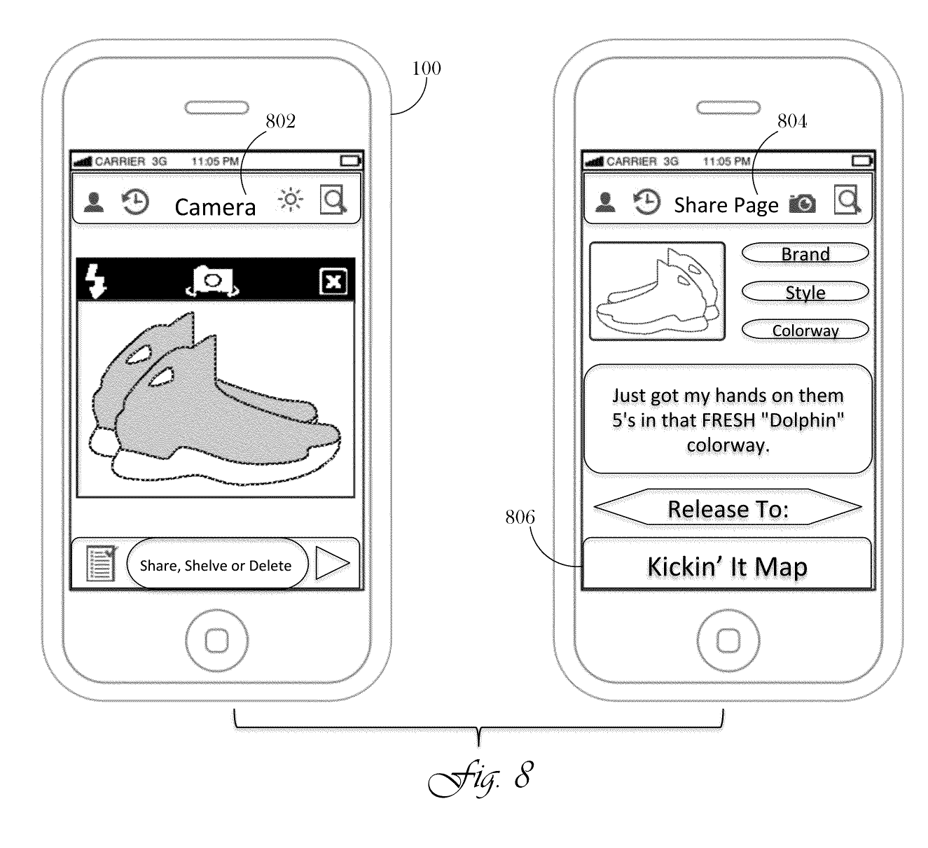

FIG. 8 shows an embodiment of the electronic device 100, the Camera Interface 802 available to a user for taking pictures and archiving footwear data in accordance with some embodiments of the system. For example, a user can shelve, share, or delete photos. In addition, a user can employ enhanced photo editing capabilities. A shelve feature will add it to a user's Sneaker Reel module 404, which you will also be able to view within the electronic device 100.

In some embodiments, the message sharing system, via the electronic device 100, include or access a database 1202 (e.g., storage 104 of FIG. 1) storing data reflecting the footwear items currently owned by the user (e.g., access to the Cop List Interface 902 or, the Sneaker Reel module 404, or any combination thereof for viewing, storing, and modifying footwear items already owned by the user). The user can initially populate the Cop List Interface 902 or Sneaker Reel module 404 with user owned footwear by, for example, taking images of footwear items, searching footwear enthusiasts profiles, finding footwear from historical databases 1106 & 1202 (also illustrated as storage 104 of FIG. 1) of footwear retailers (e.g., from an on-line website of a footwear manufacturer), or by tagging/entering identifying information or attributes for each footwear item. After a user has tagged a picture with the brand, style, color-way, and/or left comments, the tag-enriched photo can be released to social media platforms.

Also indicated in FIG. 8, the geographical location module 806 of a message sharing system can allow a user to share geographical location to other networked footwear enthusiasts. In addition, the geographical location module 806 displays other footwear enthusiasts in the area, provides other footwear enthusiasts with information as to where the footwear item photo was taken, or where the footwear item may be purchased 1114. Moreover, the geographical location module 806 will return notifications regarding other users around you, items that they may own that are on your cop list, product available in your vicinity that appear on your cop list, and items you have available that appear on their cop list, the Share Page Interface 804 will allow a user to share messages & information across Internet forums, electronic mailing lists, blogs and microblogs, and social networks. In any of these systems, users may post messages that can be read by other footwear enthusiasts of the message sharing system.

In some aspects, an electronic device (e.g., electronic device 100 of FIG. 1) may include an integrated application operative for a message sharing system to keep footwear wish lists in order. For example, the message sharing system shows an exemplary Cop List Interface 902 that allows a user to switch from a pictorial display 1118 to a text list when the pictorial collage becomes cluttered. In conjunction, the Advertisement Interface 904 provides direct enriched information from footwear providers and manufacturers. In addition, the exemplary Cop List Interface 902 permits a user to add or subtract footwear items from the wish list.

In one embodiment, the message sharing system can automatically update the database, for example storage 104 of FIG. 1, by including footwear items into the database, for example database 1202 of FIG. 12, as they are purchased by the user (e.g., as determined from a communication between footwear providers and the electronic device, or from a payment source used to purchase footwear and the electronic device using communication circuitry 110 of FIG. 1).

In some embodiments, a single, message sharing system via an integrated application on an electronic device 100 can search footwear items. For example, the message sharing system shows an exemplary Search Engine Interface 1002 in accordance with some embodiments. Moreover, the message sharing system can search by hash tags, screen names, or key words. In some embodiments, a user can add researched footwear item to the Cop List Interface 902 or Preferred Closets Interface 704. In one embodiment, the footwear picture collage displays 1118 the most viewed and popular footwear items.

### Additional Considerations

Throughout this specification, plural instances may implement components, operations, or structures described a single instance. Although individual operations of one or more methods are illustrated and described as separate operations' one or more of the individual operation may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

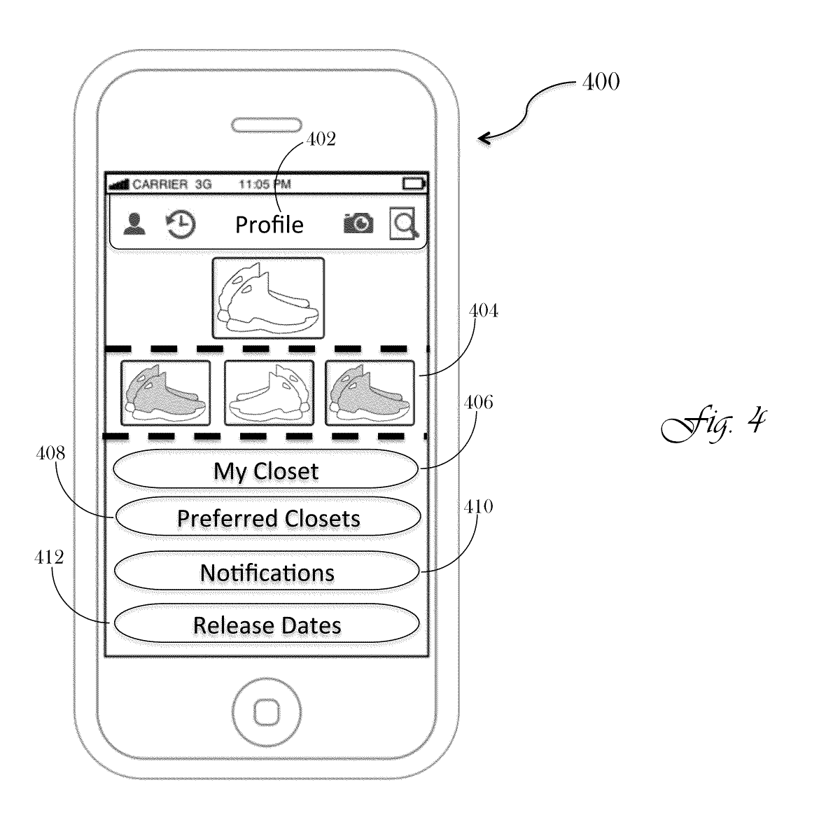

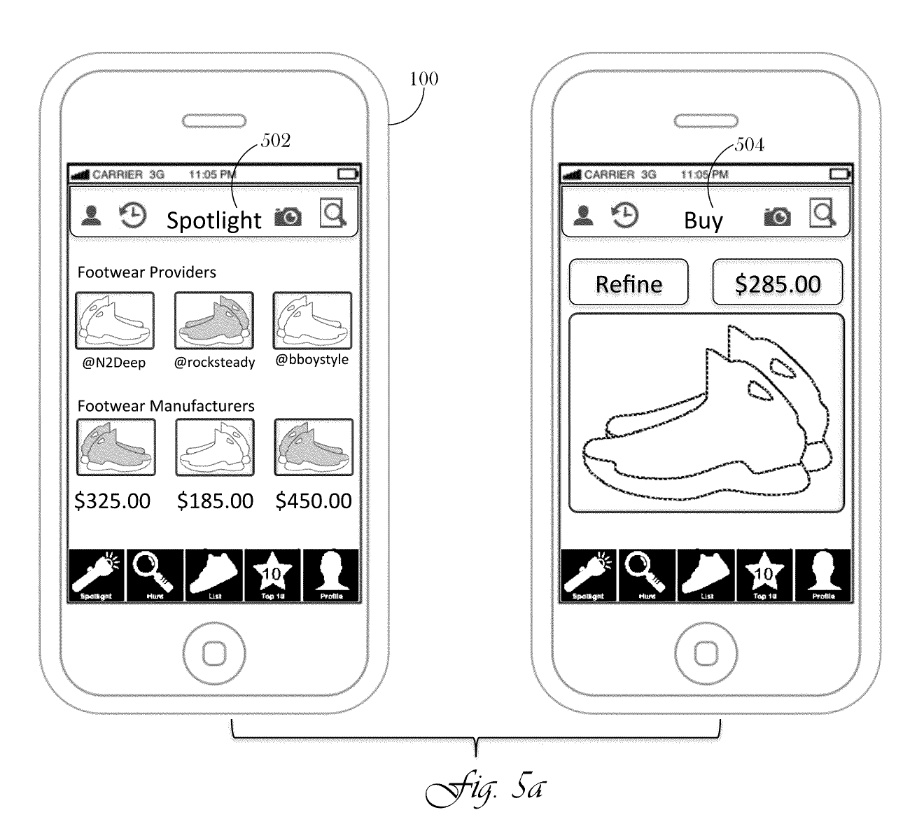

Certain embodiments are described herein as including logic or a number of components, modules, or mechanisms, e.g., as described in FIGS. 3, 4, 6, 8, and 12. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

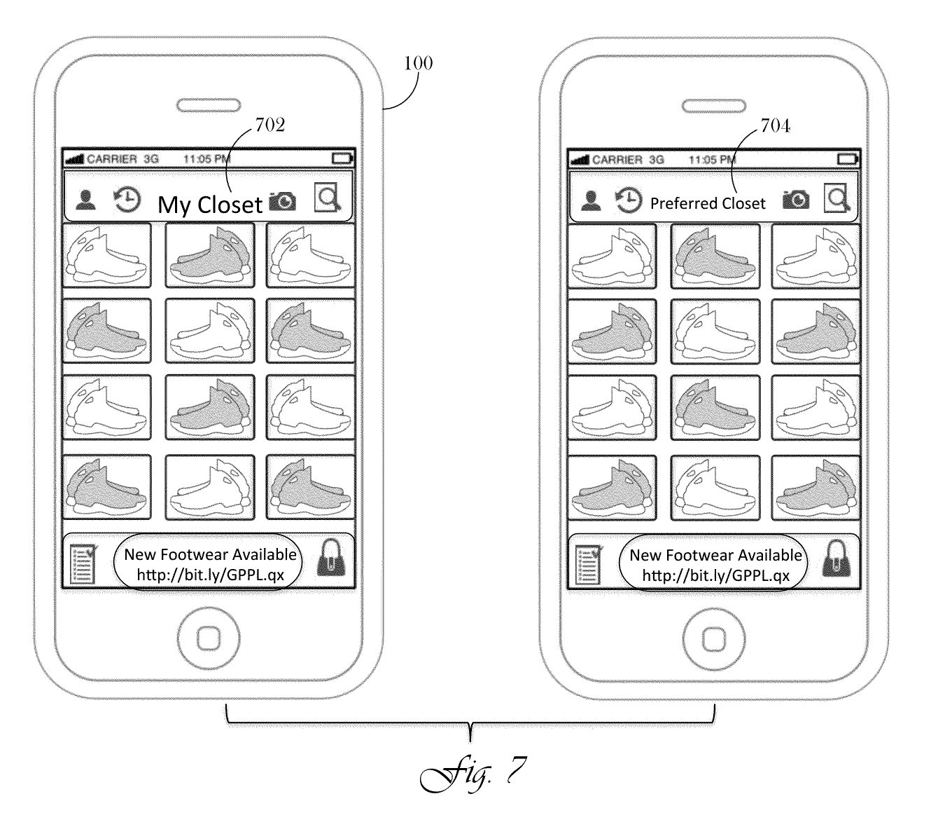

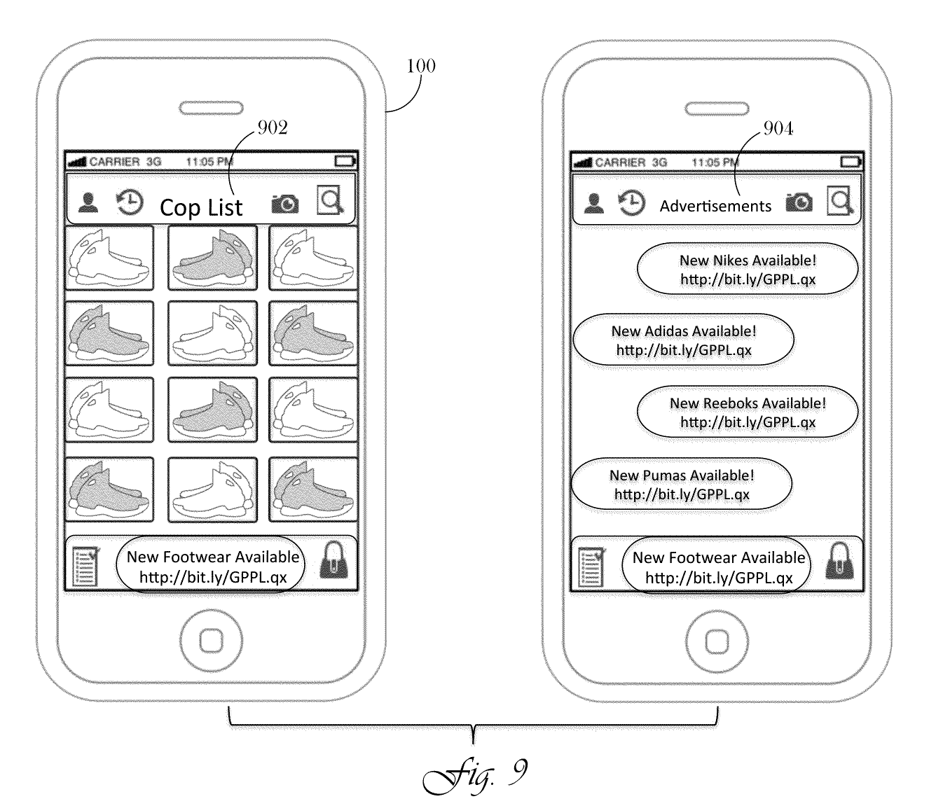

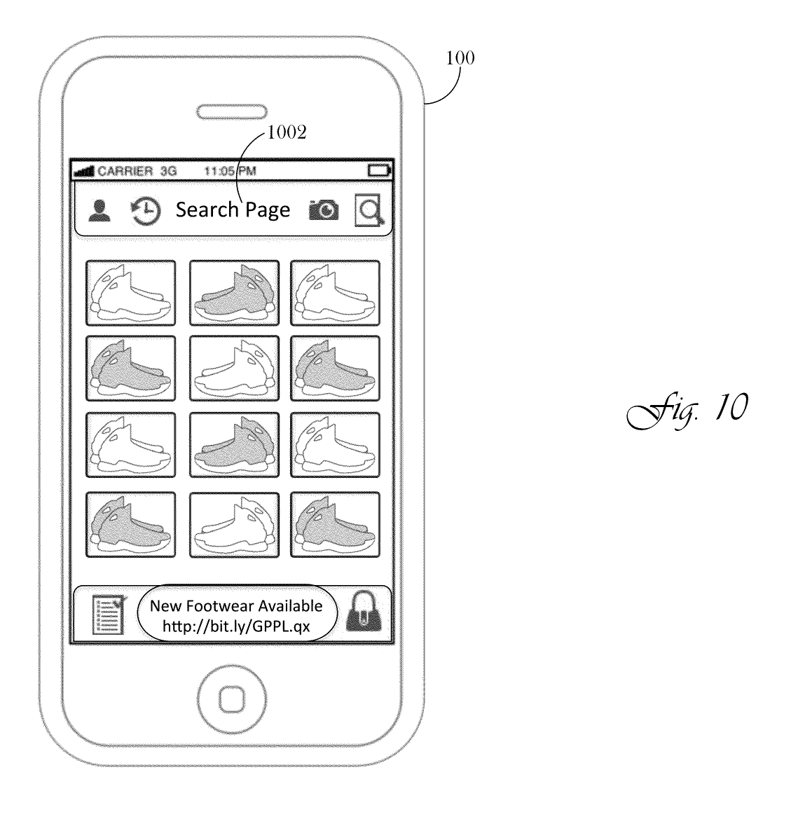

The various operations of example methods described herein, e.g., with FIGS. 2-11, may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 1204 (e.g., the Internet) and via one or more appropriate interfaces (e.g., application program interfaces (APIs).

Some portions of this specification are presented in terms of algorithms or symbolic representations of operations on data stored as bits or binary digital signals within a machine memory (e.g., a computer memory, storage 104, or memory 106 in FIG. 1 or database 1202 in FIG. 12). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “analyzing,” “processing,” “computing,” “compiling,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, nonvolatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosed system. This description should be read to include one or at least one and the singular also includes the plural unless it is obvious that it is meant otherwise.

Upon reading this disclosure, those of skill in the art will appreciate still additional alternative structural and functional designs for systems and processes for providing footwear enthusiast interface mechanics relating to the disclosed message sharing system principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### CONCLUSION

The process discussed above is intended to be illustrative and not limiting. Persons skilled in the art could appreciate that steps of the process discussed herein can be omitted, modified, combined, or rearranged, and any additional steps can be performed without departing from the scope of the invention.

The invention can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer readable medium can also be distributed over network coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

While various embodiments have been described above, it should be understood that they have been presented by way of example only, and not limitation. For example, any of the elements associated with the footwear enthusiast message sharing system may employ any of the desired functionality set forth hereinabove. Thus, the breadth and scope of a preferred embodiment should not be limited. Finally, the scope of the invention should be determined by the appended claims and their legal equivalents, rather than by the examples given.

1. (canceled)

2. A computer-implemented method of interfacing messages in a footwear enthusiast message sharing system, the method comprising:
Monitoring a plurality of footwear items in a footwear enthusiast message sharing system
Receiving electronic messages posted by a plurality of users
Compiling and analyzing user uploaded footwear data, photographic footwear data, and electronic messages
Storing footwear item data in a database
Generating a plurality of news notifications regarding one or more of the footwear items wherein the news information is for presentation to one or more users
Generating a plurality of footwear release date notifications regarding one or more of the footwear items wherein the footwear release date information is for presentation to one or more users
Subscribing one or more of a plurality of users to other footwear enthusiasts for message sharing
Determining availability of wish list footwear items for exchange or sell in a database
Facilitating footwear item transactions
Transmitting select electronic messages amongst users
Displaying footwear item data comprising one or more of the plurality of footwear items to at least one user

3. The method of claim 2, wherein facilitating footwear item transactions comprises:
identifying new footwear available for purchase; and
monitoring current buying trends to determine at least one popular item.

4. The method of claim 2, wherein the transmitting electronic messages comprises at least one of an e-mail, a text message, a voicemail, a pop-up notification, and a push notification.

5. The method of claim 4, wherein the transmitting electronic messages further comprises:
forwarding subscriber communications; and
dispatching messages on footwear item photos.

6. The method of claim 2, wherein compiling user uploaded footwear data and electronic messages further comprising capturing footwear preferences of the user.

7. The method of claim 6, wherein the communication medium further comprising subscribing footwear enthusiasts to a user.

8. The method of claim 2, wherein determining availability of wish list footwear items for exchange or sell in a database comprises updating a database of footwear items in response to the user purchasing footwear or adding footwear to the photographic collage.

9. The method of claim 2, wherein compiling user uploaded footwear data, photographic footwear data, and electronic messages comprises providing opportunities to survey the user after log-in.

10. The method of claim 9, wherein providing opportunities to survey the user further comprises:
accepting user ratings;
averaging user ratings; and
displaying ratings in a color coded method.

11. An electronic device for interfacing with a footwear enthusiast message sharing system, the electronic device comprising:
At least one processor operable to run an integrated application providing functions to:
Monitor a plurality of footwear items in a footwear enthusiast message sharing system
Store footwear item data in a database
Compile and analyze user uploaded footwear data, photographic footwear data, and electronic messages
Generate a plurality of news notifications regarding one or more of the footwear items wherein the news information is for presentation to one or more users
Generate a plurality of footwear release date notifications regarding one or more of the footwear items wherein the footwear release date information is for presentation to one or more users.
Subscribing one or more of a plurality of users to other footwear enthusiasts for message sharing
Determine availability of wish list footwear items for exchange or sell in a database
a camera operable to capture digital images of at least one footwear item of interest; and
communication circuitry operable to transmit footwear enthusiast messages associated with the at least one footwear item.

12. The electronic device of claim 11, wherein the processor is further operable to:
identify the footwear item of interest from the digital image; and
add the identified footwear item to a cop/wish list of the user.

13. The electronic device of claim 11, wherein the communication circuitry is further operable to establish network operations to facilitate transactions and/or exchanges.

14. The electronic device of claim 11, wherein the message sharing system comprise providing for footwear enthusiasts of the message sharing system to provide feedback on a footwear item of interest.

15. The electronic device of claim 11, wherein the electronic device further comprises a display component, and wherein:
the processor is further operable to:
identify geographical location of the user;
direct the display component to generate a map of footwear enthusiasts in the area of the user; and
share geographical location to footwear enthusiasts of a social network.

16. The electronic device of claim 11, wherein the camera is further operable to capture a digital image of a price tag of a particular footwear item; and
the processor is further operable to:
identify a barcode within the digital image;
identify enriched information of the particular footwear item, wherein the enriched information is associated with the barcode; and
transmit the enriched footwear information to the user.

17. The electronic device of claim 11, wherein the footwear item data comprises at least one of availability, price, style, color, brand, footwear provider, and ratings of the particular footwear item.

18. The electronic device of claim 11, wherein the processor is further operable to:
process a visual query messages including a footwear image, comprising, one or more processors for executing programs; and
memory storing one or more programs be executed by the one or more processors.

19. The electronic device of claim 18, wherein the executing programs further comprises instructions for:
receiving from a user, a visual query message comprising one or more footwear images;
identifying potential image matches that potentially match the respective footwear image, the potential image matches comprising images from one or more image sources identified in accordance with data regarding the requester;
identifying one or more footwear items associated with the potential image matches;
retrieving, for each identified footwear item, footwear item-specific enriched information obtained from a plurality of shared messages;
generating an ordered list of footwear items by ranking the one or more identified footwear items in accordance with similarity between the respective footwear item image and the potential footwear item trademark and design image; and
sending to the user at least one footwear item identified from the ordered list.

20. A non-transitory computer-readable media for interfacing with a footwear enthusiast message sharing system, the computer-readable media storing computer executable instructions that, when executed, cause at least to one processor to:
Receive electronic messages posted by a plurality of users, monitor a plurality of footwear items in a footwear enthusiast message sharing system, store footwear item data in a database, compile user uploaded footwear data, and transmit select electronic messages from users;
Generate a plurality of news notifications and footwear release date notifications regarding one or more of the footwear items wherein the footwear release date information is for presentation to one or more users; and
Display footwear item data comprising one or more of the plurality of footwear items to at least one user.

21. The non-transitory computer-readable media for interfacing with a footwear enthusiast message sharing system of claim 20, wherein the system determines availability of wish list footwear items for exchange or sell in a database and facilitate footwear item transactions.
